(19) United States
(12) Patent Application Publication
(10) Pub. No.: US 2019/0253752 A1
(43) Pub. Date: Aug. 15, 2019

(54) COMMUNICATION SYSTEM WITH CONTENT RECEIVER ABLE TO MANAGE A CALL DURING A BROADCAST, AND ASSOCIATED MANAGEMENT METHOD

(71) Applicant: SAGEMCOM BROADBAND SAS, RUEIL MALMAISON (FR)

(72) Inventor: Arnaud COFFINET, RUEIL MALMAISON (FR)

(21) Appl. No.: 16/342,028

(22) PCT Filed: Oct. 3, 2017
(86) PCT No.: PCT/EP2017/075059

§ 371 Date: Apr. 15, 2019

(30) Foreign Application Priority Data
Oct. 14, 2016 (FR) 1659983

(51) Int. Cl. H04N 21/433; H04N 21/41; H04L 29/06; H04N 21/4147

(52) U.S. Cl. CPC H04N 21/4334; H04N 21/4135; H04N 21/4113; H04L 65/1006; H04L 65/1023; H04N 21/4147; H04L 65/1046

(57) ABSTRACT

A communication system is coupled to a fixed telephone and a mobile telephone and includes a gateway coupled to a multimedia contents receiver, coupled to a monitor and including a content recording system, and a controller arranged, when an incoming call is detected during the broadcasting of a content by the monitor, to trigger the temporary interruption of this broadcasting, the recording of the rest of the content received, and the displaying on the monitor of a message prompting the user to accept or to refuse this incoming call, and then, in case of acceptance, to force continuation of the recording until the end of call is detected.

The invention relates to communication systems that include a gateway coupled to a multimedia content receiver, and more specifically the management of telephone calls that are received by such communication systems during the broadcasting of multimedia content.

As known by those skilled in the art, certain communication systems, on the one hand, include a communication gateway coupled to a multimedia content receiver also coupled to a monitor and having recording means able to record a content being received, and, on the other hand, coupled to a fixed telephone and/or to a mobile telephone. Generally the (communication) gateway is coupled to the fixed telephone, to an internet service provider (or ISP), and optionally to content supply means (cable and/or optic fibre and/or television antenna and/or satellite dish), and the multimedia content receiver is coupled to a display monitor (such as for example a television set or a computer screen) and to at least one mobile telephone (for example via a Bluetooth link).

It will be noted that the invention relates not just to communication systems in which the gateway and the multimedia content receiver form part of the same device, but also to communication systems in which the gateway and the multimedia content receiver are two devices coupled via a wired or wireless link. It will also be noted that the multimedia content receiver may, for example, be what those skilled in the art call a “Personal Video Recorder Set Top Box” (or PVR STB), with a decoder function.

Several known communication systems propose a function making it possible to detect an incoming (telephone) call during the broadcasting of a content on the associated monitor, and to launch a recording of this content in the (multimedia content) receiver consecutively to this call detection, either automatically, or at the request of the user. However none of these communication systems proposes a management of incoming calls from the receiver (and notably an acceptance or a refusal or hang up). What is more, most of these communication systems have to comprise an additional peripheral to be able to detect incoming calls.

Certainly the Apple Company has proposed a call management, but without possibility of recording the content (or multimedia programme) watched. The calls must obligatorily go through an application called FaceTime® and can only be received on a personal computer or a smartphone of iPhone type or an electronic tablet of iPad type or a television set via the application called AppleTV®. In other words, the implementation of the single call management obligatory imposes having Apple brand devices.

The aim of the invention is thus notably to improve the situation.

It proposes notably to this end a method intended to enable the management of an incoming telephone call for a communication system including a (communication) gateway coupled to a multimedia content receiver which is also coupled to a monitor and which has recording means able to record a content being received, this communication system further being coupled to a fixed telephone and/or to a mobile telephone.

This method is characterised by the fact that it includes a step in which, in the event of detection of an incoming telephone call by the communication system during a broadcasting of a content by the monitor:
this broadcasting is temporarily interrupted while recording with the recording means the remainder of the content received by the communication system, and on the monitor is displayed a message prompting a user of said monitor to accept or to refuse this detected incoming telephone call, then, in the event of acceptance, the recording of the remainder of the received content is continued with the recording means until the end of the telephone call is detected.

Thus, it is possible to immediately place on “pause” and record the content (or programme) that is broadcast live while receiving a telephone call, while being capable of managing this telephone call from the receiver without addition of an additional peripheral.

The management method according to the invention may comprise other characteristics which may be taken separately or in combination, and notably:
in its step, when the end of the telephone call has been detected, it is possible to display on the monitor a message proposing to the user the broadcasting by said monitor of the remainder of the content being received or of the remainder of the recorded content while continuing the recording of the remainder of the received content;
in its step, in the event of refusal of the user to answer the incoming telephone call, it is possible to display on the monitor a message proposing to this user the broadcasting by said monitor of the remainder of the content being received or of the remainder of the recorded content while continuing the recording of the remainder of the received content;
in its step the communication system may consider that the user accepts the incoming telephone call when he has selected an acceptance zone displayed on the monitor by means of a remote control associated with the multimedia content receiver or a dedicated button of this remote control or that he has taken the incoming telephone call by means of the fixed or mobile telephone that has received said call;
in its step, when the user accepts the incoming telephone call by means of the remote control, it is possible to broadcast the sounds coming from the fixed or mobile telephone by means of the monitor or an audio peripheral attached to the monitor and it is possible to capture the sounds emitted by the user with a microphone of the remote control in order to transfer them to the fixed or mobile telephone (that has received the telephone call).

The invention also proposes a communication system including a (communication) gateway coupled to a multimedia content receiver that is able to be coupled to a (display) monitor and which comprises recording means able to record a content being received, this communication system further being able to be coupled to a fixed telephone and/or to a mobile telephone.

This communication system is characterised by the fact that it also includes control means arranged, in the event of detection of an incoming telephone call (by the communication system) during a broadcast of a content by the monitor:
to trigger a temporary interruption of this broadcasting and a recording by the recording means of the remainder of the content received by the communication system, and to trigger a display on the monitor of a message prompting a user of said monitor to accept or to refuse this detected incoming telephone call, then
in the event of acceptance of the incoming telephone call, to impose a continuation of the recording of the remainder of the received content by the recording means up to a detection of end of the telephone call.

The communication system according to the invention may comprise other characteristics which may be taken separately or in combination, and notably:
its control means may be arranged, when an end of the telephone call has been detected, to trigger a display on the monitor of a message proposing to the user the broadcasting by said monitor of the remainder of the content being received or of the remainder of the recorded content while imposing a continuation of the recording of the remainder of the received content;
its control means may be arranged, in the event of refusal of the user to answer the incoming telephone call, to trigger a display on the monitor of a message proposing to this user the broadcasting by said monitor of the remainder of the content being received or of the remainder of the recorded content while imposing a continuation of the recording of the remainder of the received content;
it may also include a remote control associated with the multimedia content receiver. In this case, its control means may be arranged to consider that the user accepts the incoming telephone call when he has selected an acceptance zone displayed on the monitor by means of a remote control associated with the multimedia content receiver or a dedicated button of this remote control or that he has taken the incoming telephone call by means of the fixed or mobile telephone that has received said call;
the remote control may include a microphone able to capture the sounds emitted by the user, and its control means may be arranged, when the user has accepted the incoming telephone call by means of the remote control, to control the broadcasting of the sounds coming from the fixed or mobile telephone (having received the telephone call) by means of the monitor or an audio peripheral attached to the monitor and the transfer to this fixed or mobile telephone of the sounds captured by the microphone;
in a first embodiment its gateway and its multimedia content receiver may form part of a same device able to be coupled to the monitor and to the fixed telephone and/or to the mobile telephone;
in a second embodiment its gateway may be coupled to the multimedia content receiver via a wired or wireless link and may be able to be coupled to the fixed telephone, and its multimedia content receiver may be able to be coupled to the monitor and to the mobile telephone;
its control means may form part of the multimedia content receiver.

The invention also proposes a multimedia content receiver, on the one hand, able to be coupled to a mobile telephone, a monitor and a (communication) gateway able to be coupled to a fixed telephone, and, on the other hand, comprising recording means able to record a content being received. This receiver is characterised by the fact that it includes control means arranged, in the event of detection of an incoming telephone call received by the mobile telephone or the fixed telephone during a broadcast of a content by the monitor, to trigger a temporary interruption of the broadcasting and a recording by the recording means of the remainder of the received content, and to trigger a display on the monitor of a message prompting a user of said monitor to accept or to refuse the detected incoming telephone call, then, in the event of acceptance, to impose a continuation of the recording of the remainder of the received content by these recording means up to a detection of end of the telephone call.

The invention also proposes a computer programme product including instructions which, when the programme is executed by a computer, lead said computer to implement the steps of the method according to a possible combination of the aforementioned steps.

The invention also relates to a non-transitory recording support readable by computer including instructions which, when they are executed by a computer, lead said computer to implement the steps of the method according to a possible combination of the aforementioned steps.

Other characteristics and advantages of the invention will become clear on examining the detailed description hereafter, and the appended drawings, in which:

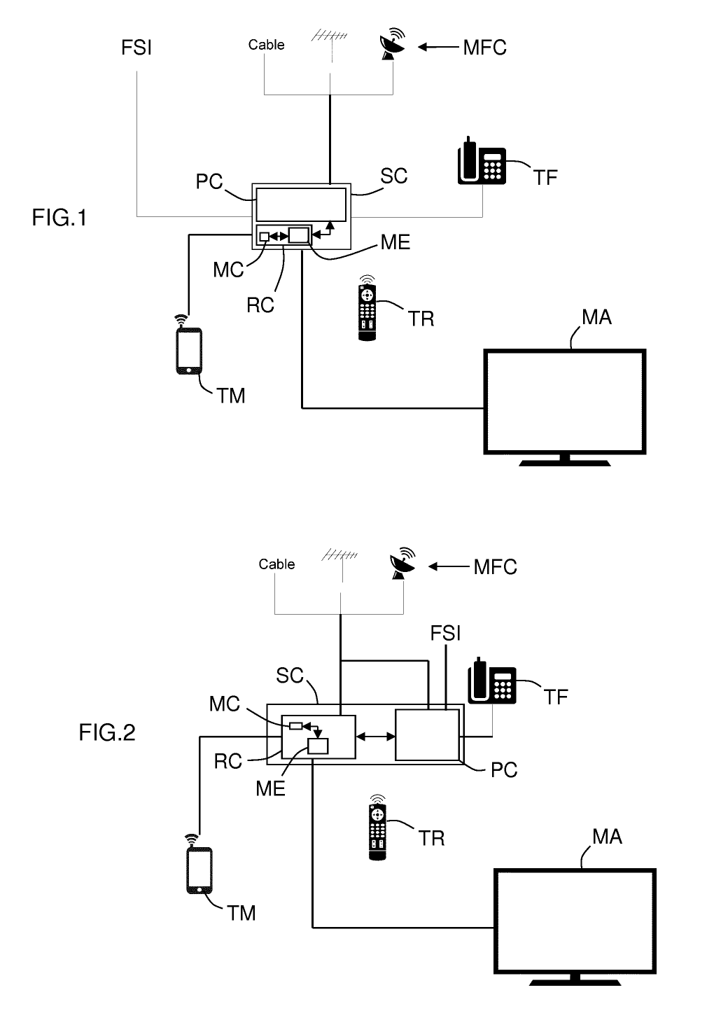

FIG. 1 illustrates in a schematic and functional manner a first exemplary embodiment of a communication system according to the invention, and

FIG. 2 illustrates in a schematic and functional manner a second exemplary embodiment of a communication system according to the invention.

The aim of the invention is notably to propose a management method intended to enable the management of an incoming telephone call for a communication system SC including a (communication) gateway PC coupled to a multimedia content receiver RC, during the broadcasting of a multimedia content.

In FIGS. 1 and 2 are schematically illustrated two exemplary embodiments of a communication system SC according to the invention to which are coupled, as non-limiting example, a (display) monitor MA, a fixed telephone TF, a mobile telephone TM, multimedia content supply means MFC, and an internet service provider (or ISP) FSI.

It will be noted that in order that the invention can be implemented, it suffices that the communication system SC is coupled to a fixed (TF) or mobile (TM) telephone and to a multimedia content supply means MFC.

In the examples illustrated in a non-limiting manner, the (display) monitor MA is a television set. But it could also be a computer screen (desktop or laptop).

Furthermore, the multimedia content supply means MFC may, for example, include an Ethernet network cable and/or an optic fibre and/or a television antenna and/or a satellite dish and/or a cable input (for example of DVB-C/DVB C2 type or any other broadcasting standard on cable network).

As illustrated, a communication system SC, according to the invention, includes at least a gateway PC, a multimedia content receiver RC and control means MC.

The gateway PC may be of residential or domestic type. It is coupled to the fixed telephone TF as well as the optional internet service provider FSI and optionally to the multimedia content supply mean(s) MFC.

The (multimedia content) receiver RC is coupled to the mobile telephone TM, to the monitor MA and to the multimedia content supply mean(s) MFC. The coupling between the receiver RC and the monitor MA may be achieved by a wired link (of digital video or analogue video type) or by a wireless link. Furthermore, this receiver RC includes recording means ME which are able to record live a (multimedia) content that is being received by its communication system SC.

For example, the receiver RC may be a Personal Video Recorder Set Top Box (PVR STB), with a decoder function.

In the first exemplary embodiment, the gateway PC and the receiver RC form part of a same device within which they are coupled by a wired or wireless link. This thus represents a fully integrated device. It will be noted that the gateway PC and the receiver RC could be integrated in the form of a single electronic equipment, or instead be realised in the form of a software running on a common microprocessor.

In the second exemplary embodiment, the gateway PC and the receiver RC are two devices that are remote from one another and coupled via a wired link (for example of LAN (Local area Network)) type or wireless link (for example of WAN (Wireless Area Network)) type.

As mentioned previously, the invention proposes a management method intended to manage incoming telephone calls in the communication system SC while a (multimedia) content being received by the latter (SC) is broadcast live by the monitor MA.

Such a method may be implemented at least partially by the control means MC of the communication system SC. In the non-limiting examples illustrated in FIGS. 1 and 2, the control means MC form part of the receiver RC. But this is not obligatory. Indeed, and although this is not preferred, they could constitute an equipment coupled to the receiver RC. Consequently, the control means MC may be realised in the form of software (or computer) modules, or instead a combination of electronic circuits (or hardware) and software modules. It will be noted that the management of the mobile telephone TM requires that the receiver RC has a Bluetooth functionality with HF profile.

A management method, according to the invention, includes a step that is implemented each time that an incoming (telephone) call is detected, during the broadcasting of a content by the monitor MA, by the communication system SC. This detection is realised by the gateway PC if the incoming (telephone) call relates to the fixed telephone TF. If it relates to the mobile telephone TM, the detection of the call is realised by said mobile telephone (TM), but the latter (TM) transmits the alert of the incoming call to the receiver RC. It is thus possible to say that the receiver RC only notifies the incoming call.

In this step, when the aforesaid condition arises, the broadcasting is temporarily interrupted (or paused) while recording with the recording means ME the remainder of the content received by the communication system SC (via the content supply means MFC), and on the monitor MA is displayed a message prompting a user of said monitor (MA) to accept or to refuse the detected incoming call.

It will be understood that it is the control means MC that are arranged to trigger the temporary interruption of the broadcasting and the recording by the recording means ME of the remainder of the content received by the communication system SC, and to trigger the display on the monitor MA of the message prompting the user to accept or to refuse the detected incoming call.

Next in this step, in the event of acceptance of the call by the user, the recording of the remainder of the received content is continued with the recording means ME until the end of this call is detected.

It will be noted that once the end of call has been detected it is next possible to display on the monitor MA a message proposing to the user the broadcasting by said monitor (MA) of the remainder of the content being received by the communication system SC or of the remainder of the content recorded by the recording means ME while continuing the recording of the remainder of the received content via the content supply means MFC. But this broadcasting could be automatic as of the detection of the end of the call or instead consecutive to an order supplied by the user.

It will be understood that it is the control means MC that are arranged to impose the continuation of the recording of the remainder of the content received by these recording means ME up to the detection of the end of the call, then, optionally, to trigger the display on the monitor MA of the message proposing to the user the broadcasting of the remainder of the content being received or of the remainder of the recorded content while imposing the continuation of the recording of the remainder of the received content.

The invention thus makes it possible, immediately after the detection of an incoming call, to pause the content (or programme) that is broadcast live on the monitor MA, and to start the recording of the remainder of this content (or programme) while managing this call from the receiver RC without it being obligatorily necessary to add an additional peripheral and without intervention of the user. The receiver RC thus becomes, in a sense, a “hands-free” type device.

It will be noted that the detection of the incoming call is very rapid due to the fact that it is carried out in the gateway PC or in the mobile telephone TM. Hence, it is no longer necessary to wait for the ringing of the telephone and its detection to act. This detection can, for example, be done by notifications of SIP (Session Initiation Protocol) messages if the call comes from the fixed telephone TF, or by notifications of Bluetooth messages if the call comes from the mobile telephone TM.

For example, in the step of the method, in the event of refusal of the user to answer the incoming call, it is possible to display on the monitor MA another message proposing to this user the broadcasting by said monitor (MA) of the remainder of the content being received by the communication system SC or of the remainder of the content recorded by the recording means ME while continuing the recording of the remainder of the received content via the content supply means MFC.

It will be understood that it is the control means MC that are arranged to trigger the display on the monitor MA of this other message while imposing the continuation of the recording of the remainder of the received content.

Also for example, in the step of the method the communication system SC may consider that the user accepts the incoming call when he has selected an acceptance zone displayed on the monitor MA by means of a remote control TR that is associated with the receiver RC or a dedicated button of this remote control TR or that he has taken the incoming call by means of the fixed TF or mobile TM telephone that has received said call.

It will be understood that it is the control means MC that are arranged to perform this consideration.

In the presence of this latter option, when the user accepts the incoming call by means of the remote control TR, it is possible to broadcast the sounds that are coming from the fixed TF or mobile TM telephone (which receives the call) by means of loudspeakers of the monitor MA or an audio peripheral attached to the monitor MA, and it is possible to capture the sounds emitted by the user with a microphone that includes the remote control TR in order to transfer them to this fixed TF or mobile TM telephone.

It will be understood that it is the control means MC that are arranged to control the broadcasting of the sounds coming from the fixed TF or mobile TM telephone and the transfer of the sounds captured by the microphone to the fixed TF or mobile TM telephone.

In order to be able to convey the audio flux captured by its microphone, the remote control TR may, for example, be of Bluetooth type.

The gateway PC and the receiver RC can exchange “event” type information on the call underway, for example by using an Ethernet or WiFi type network communication protocol. As an example, this protocol may be SIP. In order to enable this exchange of information and audio flux, it is possible, for example, to create a virtual local network (or VLAN (Virtual LAN)) between the gateway PC and the receiver RC. The VLAN will be preferably internal in the device in the first exemplary embodiment (fully integrated), and external going through a link (LAN or WAN) between the gateway PC and the receiver RC in the second exemplary embodiment.

When the options described above are present, the receiver RC is thus capable of managing the incoming call by proposing to the user on the monitor MA the following options, accessible notably by means of the remote control TR:
to accept the call in hands-free mode, whether it comes from the fixed telephone TF or from the mobile telephone TM,
to refuse the call and to resume viewing of the content (or programme) at the point where it had been interrupted consecutively to the call detection,
to refuse the call and not resume the reading of the content (or programme).

Furthermore, the control means MC may optionally be arranged to trigger the display on the monitor MA of the name or the telephone number of the caller and/or the duration of the communication.

In addition, the receiver RC managing the call, it automatically detects the end of the call and thus can immediately and automatically propose to the user the resumption or not of the reading of the content (or programme), by displaying message(s) on the monitor MA.

It will also be noted that the remote control TR associated with the receiver RC may be optionally enriched by one or more function buttons dedicated to telephony (to take the call and to refuse the call). But it could also be possible to use the scroll and selection buttons of the remote control TR to choose the telephony management options displayed on the monitor MA.

Three situations able to be managed by the control means MC are described hereafter as examples.

In a first example the user is watching a programme on the monitor MA via the receiver RC while having his fixed telephone TF out of his reach, unless he moves. When his fixed telephone TF receives a call, the control means MC are informed thereof and automatically trigger the pause of the broadcasting of the programme and the recording of the remainder of said programme, then trigger the display on the monitor MA of a message indicating that a call coming from Mr X is underway on the fixed telephone TF. For example, the user can move to pick up his fixed telephone TF. In this case, the control means MC can trigger the display on the monitor MA of a message indicating that the call has been taken and the duration of the communication. Once the call has ended the control means MC are informed thereof by the gateway PC and can propose to the user to resume the viewing of his programme at the point where it had been interrupted or to resume the live broadcasting of the programme.

In a second example the user is watching a programme on the monitor MA via the receiver RC while optionally having his mobile telephone TM out of his reach, unless he moves. When his mobile telephone TM receives a call, the control means MC are informed thereof and automatically trigger the pausing of the broadcasting of the programme and the recording of the remainder of said programme, then trigger the display on the monitor MA of a message indicating that a call coming from Mr X is underway on the mobile telephone TM. For example, the user does not wish to answer the caller and indicates this via the remote control TR associated with the receiver RC. In this case, the control means MC trigger the rejection of the call then display on the monitor MA a message proposing to the user to resume the viewing of his programme at the point where it had been interrupted or to resume the live broadcasting of the programme.

In a third example the user is watching a programme on the monitor MA via the receiver RC while potentially having his mobile telephone TM out of his reach, unless he moves. When his mobile telephone TM receives a call, the control means MC are informed thereof and automatically trigger the pausing of the broadcasting of the programme and the recording of the remainder of said programme, then trigger the display on the monitor MA of a message indicating that a call coming from Mr X is underway on the mobile telephone TM. For example, the user wishes to answer the caller and indicates this via the remote control TR associated with the receiver RC. In this case, the control means MC control the broadcasting of the voice of the caller by the loudspeakers of the monitor MA and the transfer of the voice of the user (captured by the microphone of the remote control TR) to the mobile telephone TM, via the receiver RC. During the communication, the control means MC can trigger the display on the monitor MA of a message indicating that the call has been taken and the duration of the communication. Once the call has ended the control means MC are informed thereof by the receiver RC and can propose to the user to resume the viewing of his programme at the point where it had been interrupted or to resume the live broadcasting of the programme.

It will be noted that at any moment the user can interrupt the broadcasting of the remainder of a recorded content by acting on one at least one of the buttons of the remote control TR, in order to resume the live broadcasting of this content or to change content.

It will also be noted that in the case of a Bluetooth link between the receiver RC and the mobile telephone TM, the configuration of this link may be realised as indicated hereafter. Firstly it is possible to activate in the receiver RC and in the mobile telephone TM a Hands-Free Profile. The receiver RC is then considered as a Hands-Free Unit, and the mobile telephone TM is considered as an Audio Gateway Unit. Next, the receiver RC and mobile telephone TM may be paired and a Service Level Connection is established between them in order that the hands-free functionality can be available.

It will also be noted that in the event of a call of VOIP (Voice Over IP) type, it is necessary to establish an Ethernet network connection between the receiver RC and the gateway PC and to use a protocol making it possible to manage the call. To this end, it is possible, for example, to create a VLAN type virtual network between the receiver RC and the gateway PC in order to route the data, as indicated above. The protocol used may be SIP. The receiver RC may then be seen as a new telephone VOIP in addition to that which is already coupled to the gateway PC. At the SIP level, the fixed telephone TF connected to the gateway PC and the receiver RC are then considered as User Agent Servers, and the caller is considered as a User Agent Client. In order that the caller can simultaneously address the two user agent servers RC and TF, the gateway PC must also act as proxy SIP. Furthermore, the receiver RC must also integrate the user agent server functionality. In order that the functionality is active, each user agent must have successfully completed beforehand the process of registering with the proxy server SIP of the gateway PC (it is necessary in fact that the two user agent servers (TM and TF) are registered with the latter).

The invention is not limited to the embodiments of management method and control system described above, only as an example, but it encompasses all the alternatives that those skilled in the art could envisage within the sole context of the claims hereafter.

1. A method for managing an incoming telephone call for a communication system including a gateway coupled to a multimedia content receiver also coupled to a monitor and having a recording system configured to record a content being received, said communication system further being coupled to a fixed telephone and/or to a mobile telephone, the method comprising, in the event of detection of an incoming telephone call by said communication system during a broadcasting of a content by said monitor, temporarily interrupting said broadcasting while recording with said recording system the remainder of said content received by said communication system, and displaying on said monitor a message prompting a user of said monitor to accept or to refuse said detected incoming telephone call, then, in the event of acceptance, continuing said recording of the remainder of the received content with said recording system until the end of said telephone call has been detected.

2. The method according to claim 1, comprising, when the end of the telephone call has been detected, displaying on said monitor a message proposing to said user the broadcasting by said monitor of the remainder of the content being received or of said remainder of the recorded content while continuing said recording of the remainder of the received content.

3. The method according to claim 1, comprising, in the event of refusal to answer said incoming telephone call, displaying on said monitor a message proposing to said user the broadcasting by said monitor of the remainder of the content being received or of said remainder of the recorded content while continuing said recording of the remainder of the received content.

4. The method according to claim 1, comprising considering by said communication system that said user accepts the incoming telephone call when the user has selected an acceptance zone displayed on said monitor by means of a remote control associated with said multimedia content receiver or a dedicated button of said remote control or that the user has taken said incoming telephone call by means of the fixed or mobile telephone having received said call.

5. The method according to claim 4, comprising, when said user accepts the incoming telephone call by means of said remote control, broadcasting the sounds coming from said fixed or mobile telephone by means of said monitor or an audio peripheral attached to said monitor and the sounds emitted by said user are captured with a microphone of said remote control in order to transfer them to said fixed or mobile telephone.

6. A communication system including a gateway coupled to a multimedia content receiver able to be coupled to a monitor and comprising a recording system configured to record a content being received, said communication system further being configured to be coupled to a fixed telephone and/or to a mobile telephone, the communication system comprising a controller arranged, in the event of detection of an incoming telephone call by said communication system during a broadcasting of a content by said monitor, to trigger a temporary interruption of said broadcasting and a recording by said recording system of the remainder of said content received by said communication system, and to trigger a display on said monitor of a message prompting a user of said monitor to accept or to refuse said detected incoming telephone call, then, in the event of acceptance, to impose a continuation of said recording of the remainder of the received content by said recording system up to a detection of end of said telephone call.

7. The communication system according to claim 6, wherein said controller is arranged, when an end of the telephone call has been detected, to trigger a display on said monitor of a message proposing to said user the broadcasting by said monitor of the remainder of the content being received or said remainder of the recorded content while imposing a continuation of said recording of the remainder of the received content.

8. The communication system according to claim 6, wherein said controller is arranged, in the event of refusal to answer said incoming telephone call, to trigger a display on said monitor of a message proposing to said user the broadcasting by said monitor of the remainder of the content being received or of said remainder of the recorded content while imposing a continuation of said recording of the remainder of the received content.

9. The communication system according to claim 6, further comprising a remote control associated with said multimedia content receiver, and wherein said controller is arranged to consider that said user accepts the incoming telephone call when the user has selected an acceptance zone displayed on said monitor by means of said remote control or a dedicated button of said remote control or that the user has taken said incoming telephone call by means of the fixed or mobile telephone having received said call.

10. The communication system according to claim 9, wherein said remote control includes a microphone configured to capture sounds emitted by said user, and wherein said controller is arranged, when said user has accepted the incoming telephone call by means of said remote control, to control the broadcasting of the sounds coming from said fixed or mobile telephone by means of said monitor or an audio peripheral attached to said monitor and the transfer to said fixed or mobile telephone of the sounds captured by said microphone.

11. The communication system according to claim 6, wherein said gateway and said multimedia content receiver form part of a same device configured to be coupled to said monitor and to said fixed telephone and/or to said mobile telephone.

12. The communication system according to claim 6, wherein said gateway is coupled to said multimedia content receiver via a wired or wireless link and configured to be coupled to said fixed telephone, and said multimedia content receiver being configured to be coupled to said monitor and to said mobile telephone.

13. The communication system according to claim 6, wherein said controller forms part of said multimedia content receiver.

14. A multimedia content receiver configured to be coupled to a mobile telephone, a monitor and a gateway configured to be coupled to a fixed telephone, and comprising a recording system configured to record a content being received, the multimedia content receiver comprising a controller arranged, in the event of detection of an incoming telephone call received by said mobile telephone or said fixed telephone during a broadcasting of a content by said monitor, to trigger a temporary interruption of said broadcasting and a recording by said recording system of the remainder of said received content, and to trigger a display on said monitor of a message prompting a user of said monitor to accept or to refuse said detected incoming telephone call, then, in the event of acceptance, to impose a continuation of said recording of the remainder of the received content by said recording system up to a detection of end of said telephone call.

15. (canceled)

16. A non-transitory computer recording medium readable by computer and including computer readable instructions which, when the computer readable instructions are executed by the computer, lead said computer to implement the steps of the method according to claim 1.
